(19) United States
(12) Patent Application Publication
(10) Pub. No.: US 2010/0226396 A1
(43) Pub. Date: Sep. 9, 2010

(54) Optical Arrangement For Pumping Solid-State Lasers

(76) Inventor: Guenter Hollemann, Luebeck (DE)

Correspondence Address: DUANE MORRIS LLP - NY;PATENT DEPARTMENT, 1540 BROADWAY, NEW YORK, NY, 10036-4086, US

(21) Appl. No.: 12/376,393

(22) PCT Filed: Jul. 20, 2007
(86) PCT No.: PCT/DE2007/001298

§ 371 Date: Feb. 4, 2009

(30) Foreign Application Priority Data
Aug. 9, 2006 (DE) 102006039074.1

(51) Int. Cl. H01S 3/0941; H01S 3/109; H01S 3/113; H01S 3/14

(52) U.S. Cl. 372/10; 372/75; 372/22; 372/39; 372/39

(57) ABSTRACT

In an optical arrangement for pumping solid-state lasers, there is the object of producing an intensity distribution across the beam cross section of the pump radiation with a rectangular intensity profile, which intensity distribution is homogeneous at least in a region corresponding to the Rayleigh range in the direction of the beam propagation without the beam quality being substantially impaired by the homogenization. The pump arrangement contains a rod-shaped homogenizer (1) with two opposed, polished end faces (2,3), planar side limit faces (4), which are arranged parallel to the optical axis and with a cross-sectional area at right angles to the optical axis, which forms a regular polygon, with the regular polygon being restricted to those number of sides which permit a plurality of polygons to be positioned against one another on a surface in such a way that they fill the space.

### RELATED APPLICATIONS

The present application is a U.S. National Stage application of International PCT Application No. PCT/DE2007/001298 filed on Jul. 20, 2007, which claims benefit of German Application No. DE 10 2006 039 074.1 filed on Aug. 9, 2006, the contents of each are incorporated by reference in their entirety.

### FIELD OF THE INVENTION

The present invention relates to an optical arrangement for pumping solid-state lasers which, disposed along an optical axis, comprises a diode laser pump source, a rod-shaped homogenizer, and an optical focusing system disposed in the beam path downstream of the homogenizer.

### BACKGROUND OF THE INVENTION

Solid-state lasers which comprise a disk-shaped laser crystal as the laser-active medium are characterized by a substantially axial component of the temperature gradient in the laser-active medium. The radial component of the temperature gradient, however, is responsible for the creation of the thermal lens; since, due to the disk crystal geometry, this radial component is small, such disk lasers have a practically negligible thermal lens which moreover limits the beam quality at high power levels. Disk lasers are therefore able to emit nearly diffraction-limited radiation even at high power levels.

Disk lasers can be suitably used to generate a continuous-wave (CW) beam and for pulsed operation and are especially useful for doubling or tripling frequency inside the resonator.

The laser-active media to be used include various laser crystals and, especially for CW operation, optically pumped semiconductor lasers.

Disk lasers are preferably pumped by diode lasers which are characterized by a highly asymmetrical beam profile which, perpendicular to the PN junction, has a nearly diffraction-limited beam quality and, parallel to the PN junction, can have a low beam quality with a times-diffraction-limit factor M², for example, of 500. The intensity distribution across the beam cross section is generally inhomogeneous and highly structured.

Thus, it is necessary to combine, transform, homogenize and focus the beam of one or more diode lasers or horizontal diode laser stacks in such a manner that a highly homogeneous and rectangular intensity distribution of the pump beam fowls on the disk-shaped laser crystal. The objective of the measures was to achieve, for example, an approximately round pump beam focus with a diameter of 2 wₚ with a rectangular intensity distribution across the beam cross section, which intensity distribution corresponds, e.g., to a super-Gaussian coefficient of 10 and which has residual inhomogeneities of no more than ±5% across the beam cross section. The objective is to obtain an intensity distribution as free from structure as possible and to avoid local intensity peaks (“hot spots”). The latter are responsible for optical damage or local strains in the crystal, which can lead to wave-front distortions or to the formation of cracks in the crystal. The damage threshold of the crystal can be locally exceeded at even relatively low average intensities. This problem arises especially when high pump power levels of more than 10 W are to be used.

By using a rectangular intensity distribution, it is possible to avoid radial temperature gradients. This type of intensity distribution is to be preferred especially to a Gaussian intensity distribution, which leads to a curved wave front and frequently also to nonspherical wave-front distortions that are hard to compensate for. In contrast to rectangular distributions, Gaussian intensity distributions furthermore lead to high overshoots of the pump power density in the region near the axis.

Other requirements are that the homogenization should not lead to a significant deterioration of the beam quality of the pump beam and that a high transfer efficiency of, for example, 80% should be reached.

The low demands made by the disk laser on the beam quality of the diode lasers were to be exploited through the use of inexpensive diode laser or for increasing the pump power.

It will be obvious to the person skilled in the art that the requirement for pumping an optically pumped semiconductor laser or a longitudinally pumped rod laser is very similar and can be met equally well by the present invention.

Beam homogenizers for optical pump assemblies are sufficiently well known from the prior art (e.g., U.S. Pat. No. 4,820,010).

DE 103 93 190 T5 discloses an optical coupler which serves as a beam homogenizer; this optical coupler is disposed between a diode pump source and a thin disk-shaped gain medium and produces a light beam with a large numerical aperture.

EP 0 776 492 B1 proposes a quartz rod, a quartz fiber or a sapphire rod to obtain mode homogenization. The intensity distribution obtained is approximately Gaussian.

DE 198 36 649 C2 describes a medical handpiece comprising a beam-guiding rod in which the beam is relayed by means of total reflection, which rod has a microstructured optical input surface for the purpose of beam homogenization. The disadvantage is that manufacturing the microstructured input surface is time- and cost-intensive. In addition, by virtue of the medium used, the beam quality is significantly impaired in that the angle of divergence of the incoupled beam must necessarily increase.

C. STEWEN et al.: A 1 kW CW Thin Disc Laser, in IEEE Journal of Selected Topics in Quantum Electronics, Vol. 6, No. 4, 2000, pp. 650-657, discloses a homogenizing rod (with a length of 200 mm and a diameter of 5 mm). However, with this type of rod, it is not possible to obtain a useful homogeneous intensity distribution; instead, marked intensity overshoots, so-called “hot spots,” in the intensity distribution occur.

DE 197 55 641 A1 describes a laser diode stack which, by means of a cylindrical optical lens system directed into a glass fiber or another rotationally symmetrical optical element, is used for the purpose of pumping a disk laser. This element is also said to have a homogenizing effect. However, every rotationally symmetrical element necessarily has the disadvantage that it produces a Gaussian intensity distribution.

DE 10 2004 015 148 A1 attempts to counteract a Gaussian-like intensity distribution by inserting a conical optical system in the input of a cylindrical rod-shaped homogenizer. The disadvantage is that such an optical system is difficult to manufacture and that the beam quality is necessarily impaired due to the increase in the angle of divergence.

Apart from that, cylindrical lateral surfaces of a rod-shaped homogenizer, due to some kind of refocusing or wave guide property, invariably lead to an extremely undesirable power overshoot in the region near the axis. This power overshoot can also not be eliminated by breaking the symmetry, for example, by cutting one or more facets into the lateral surface. In cases of certain intensity distributions of the input beams, shortening a cylindrical homogenizer can even lead to a number of marked intensity peaks (“hot spots”).

From U.S. Pat. No. 5,859,868 A and US 2004/0170206 A1, it is known that antireflection-coated rods can be used to incouple laser-pumped beams.

DE 198 60 921 A1 describes a planar homogenizer which, due to the one-dimensionality of the slab laser array presented here, leads to the trivial solution described. For this application, it suffices that homogeneity in only one dimension is obtained.

### SUMMARY OF THE INVENTION

The problem to be solved by the present invention therefore is to produce, across the beam cross section of the pump beam, an intensity distribution with a homogeneous power density and with a rectangular intensity profile, which intensity distribution, in the direction of the beam propagation in the cross-sectional area, is homogeneous at least in a region that corresponds to the Rayleigh range, while ensuring that the homogenization does not significantly impair the beam quality of the pump beam.

This problem is solved with an optical arrangement for pumping solid-state lasers of the type mentioned above in such a manner that the homogenizer comprises two oppositely lying polished end surfaces as beam input and beam output surfaces, planar lateral boundary surfaces that are disposed parallel to the optical axis, and a cross-sectional area perpendicular to the optical axis, which cross-sectional area forms a regular polygon, with the regular polygon being limited to such a number of vertices [sic] that allows a space-filling side-by-side layout of a plurality of regular polygons on a plane.

Especially useful and advantageous embodiments and improvements of the optical arrangement according to the present invention follow from the dependent claims.

The cross-sectional area of the homogenizer is preferably a uniform [sic; regular] hexagon. It may also have the shape of a triangle or rectangle. The end surfaces of the homogenizer which, with their surface normal, enclose an angle from an angular range with the optical axis, which angle ranges from 0° up to and including Brewster's angle, may be coated with an antireflection coating for in- and outcoupling the pump beam.

The fact that the lateral boundary surfaces are parallel to the optical axis has the effect that the angular distribution of the exiting beam corresponds substantially to the angular distribution of the incoupled beam. If the cross-sectional area is in good conformity with the intensity distribution of the diode beam in the focus, it is possible to maintain the beam quality within good limits at a high transfer efficiency of, for example, more than 92%.

It is important to note that homogeneity must be obtained only within a narrowly confined region in the direction of the beam propagation, within which region the disk-shaped laser crystal is disposed. Outside this region, random inhomogeneity may exist, i.e., the far-field angular distribution of the component beams can be arbitrarily inhomogeneous. It is precisely this requirement that is advantageously met by the present invention.

The invention avoids a Gaussian intensity distribution of the pump beam as well as “hot spots” in the intensity distribution, thereby ensuring minimum wave front distortion and thus excellent beam quality and, at the same time, a maximum damage threshold.

When the focus is optimally adjusted, the impairment of the beam parameter product of the pump beam due to the homogenization is less than 20%.

Another improvement made possible by the invention is observed in optical pump assemblies in which the pump beam passes multiple times through the disk-shaped laser crystal. The parabolic mirrors or retro-reflecting mirrors or prisms which produce multiple passes cause a beam displacement in the optical pump system, which displacement causes the pump focus to rotate during each double pass through the disk-shaped laser crystal. As a result, for example, a hexagonal pump beam profile is rotated, for example, by 45° during each individual double pass so that, in an optical pump system that is laid out, for example, for eight double passes, the initially hexagonal pump cross section in the overlap becomes round.

Materials suitable for a transparent homogenizer include fused quartz, glass or a transparent plastic material. Also useful is a lateral surface made of a low refractive index material or of a dielectric coating, with the possibility of conforming the refractive index jump on the lateral surface to the angular distribution of the pump beam in such a manner that total internal reflection occurs across the entire angular range of the incoupled radiation.

In yet another embodiment of the present invention, the rod-shaped homogenizer can be a hollow body which is assembled from individual surface segments.

The invention also relates to homogenizers which comprise an additional subcomponent with a circular cross section.

The pump beam supplied by the diode laser pump source for pumping the disk-shaped laser crystal preferably has a pump power greater than 10 W.

The invention can furthermore be designed in such a manner that at least one beam-shaping element and a focusing lens are disposed between the diode laser pump source and the homogenizer or that the homogenizer is disposed in the beam path directly downstream of the diode laser pump source so as to directly incouple the pump beam.

Another subject matter of the invention relates to a solid-state laser which has an optical arrangement as described by this invention and which comprises a disk-shaped laser crystal as the laser-active medium within a resonator, which crystal, with one reflecting disk surface that faces away from the inside of the resonator, is mounted on a cooling element and is placed opposite a reflector so as to allow the pump beam to pass through multiple times.

The laser-active medium used is preferably a disk-shaped Yb:YAG laser crystal or other Nd- or Yb-doped laser crystals.

Inside the resonator, the solid-state laser can comprise a nonlinear optical crystal for generating the second harmonic, which crystal, in the beam path, is disposed downstream of the disk-shaped laser crystal.

However, the resonator may also comprise a Q-switch.

### BRIEF DESCRIPTION OF THE DRAWINGS

The invention will be explained in greater detail below based on the annexed drawings in which:

FIGS. 1(a), 1(b) and 1(c) are plan diagrams that illustrate regular polygons which can be arranged so as to be space-filling;

FIG. 2 is a perspective view that illustrates a preferred rod-shaped homogenizer with a hexagonal cross section;

FIG. 3 shows a pump assembly with a homogenizer as seen in FIG. 2;

FIG. 4 shows a pump assembly with a step mirror arrangement as the beam-shaping element;

FIG. 5 shows a pump assembly with direct incoupling of the pump beam into the homogenizer;

FIG. 6 shows a resonator array with a nonlinear optical crystal disposed inside the resonator for generating the second harmonic which is pumped by a pump assembly in which the pump beam is coupled directly into the homogenizer; and

FIG. 7 shows a resonator array with a Q-switch which is pumped by a pump assembly in which the pump beam is coupled directly into the homogenizer.

### DESCRIPTION OF AN EMBODIMENT OF THE INVENTION

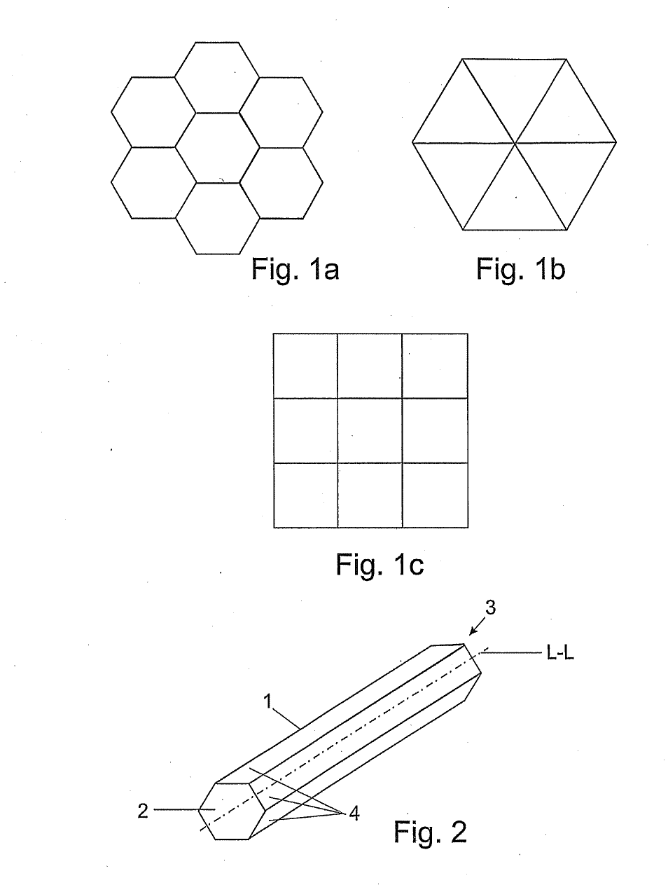

FIGS. 1a to 1c show regular polygons which can be arranged so as to be space-filling so that no gap remains between the individual polygons. These polygons are triangles, quadrangles and hexagons.

The rod-shaped homogenizer 1 shown in FIG. 2 comprises two oppositely lying polished end surfaces 2 and 3 which are preferably additionally coated with an antireflection coating so as to serve as input and output surfaces, thereby being able to effectively in- and outcouple the pump beam. The end surfaces 2 and 3 are oriented perpendicular to, and the lateral surfaces 4 are oriented parallel to, the longitudinal axis L-L of the homogenizer 1, which longitudinal axis, on application of said homogenizer, coincides with the optical axis O-O of the optical arrangement according to the present invention.

The homogenizer 1, as an optical transmission system, can be made of fused quartz, glass, a plastic material or other optical materials, or it can be a hollow conductor which is assembled from surface segments. Suitable materials to be used for the lateral surfaces of such a homogenizer include diamond-cut copper or glass, a plastic material or other optical materials.

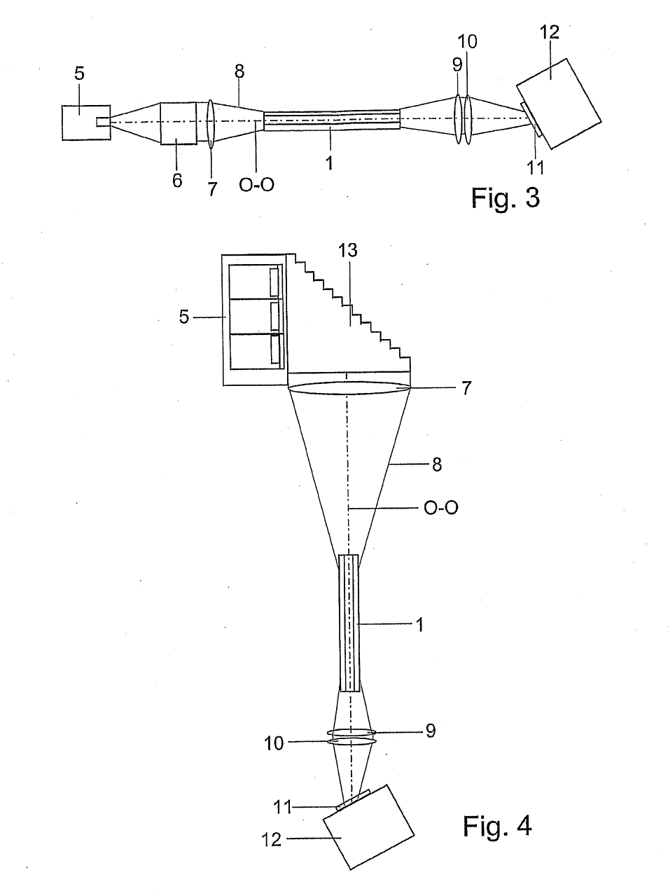

The pump assembly shown in FIG. 3 comprises a diode laser pump source 5 which includes a diode laser, a horizontal diode laser stack or a plurality of diode lasers mounted on a heat sink. Disposed downstream of the diode laser pump source 5 along the optical axis O-O are an optical beam combination and/or beam-shaping system 6 known from the art as well as a focusing lens 7, via which a supplied pump beam 8, preferably with a beam cross section that conforms to the input surface of the homogenizer 1, is coupled into the rod-shaped homogenizer 1. The objective is to maximize the transfer efficiency, which is primarily determined by the coupling efficiency, in such a manner that more than 80% of the available pump beam power is utilized. The homogenizer 1 is preferably designed as shown in the embodiment in FIG. 2, i.e., it has a cross section perpendicular to the optical axis O-O, which cross section corresponds to a regular hexagon. Other designs may also work equally well.

In the ideal case, the rod-shaped homogenizer 1 mixes the pump beam 8, which is incoupled on the input surface, on the output surface so as to obtain an intensity distribution with a rectangular intensity profile across the beam cross section of the pump beam 8. By means of an optical focusing system which comprises a recollimation lens 9 and a refocusing lens 10 and which is disposed in the beam path downstream of the homogenizer 1, this intensity profile is imaged onto a disk-shaped laser crystal 11 which is preferably disposed at an oblique angle with respect to the optical axis O-O and which, with one reflecting disk surface, is mounted on a heat sink 12 and can be an integral part of a disk laser or a disk laser gain assembly.

One embodiment of a homogenizer (not shown) provides for a homogenizer that is assembled from two subcomponents, with a first subcomponent having one of the cross sections shown in FIG. 1, while the second subcomponent has a circular cross section. Although this generally impairs the homogeneity, it also leads to an improved filling of the targeted beam cross section, which as a rule is circular.

In the embodiment shown in FIG. 4, the diode laser pump source 5 is comprised of laser diode bars which are horizontally stacked side by side. The beam-shaping element used is a step mirror arrangement 13 that is disposed between the diode laser pump source 5 and the focusing lens 7, such as has been described, for example, in DE 100 61 265 A1.

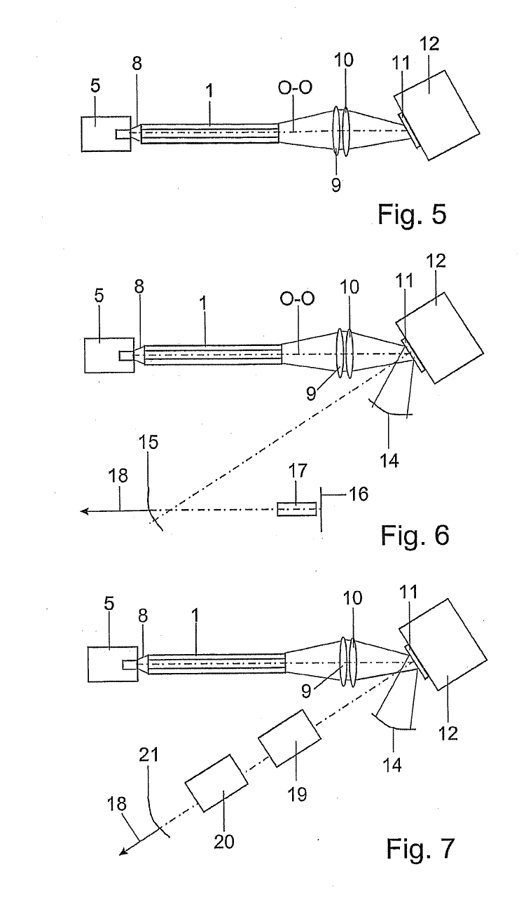

The embodiment shown in FIG. 5 does not include either an optical beam combination and/or beam-shaping system or a focusing lens, since laser diodes with a low numerical aperture are used to construct the diode laser pump source 5. Such laser diodes, for example, can have a beam angle of approximately twenty degrees so that the pump beam 8 can be coupled directly into the homogenizer 1.

The resonator array shown in FIG. 6 which is pumped by a pump assembly disclosed by this invention, comprises a retro-reflector 14 to allow the pump beam 8 to pass multiple times through the disk-shaped laser crystal 11 as well as an LBO crystal as a nonlinear optical crystal 17 for generating the second harmonic which exits from the resonator as the laser output beam 18, which LBO crystal is disposed between a dichroic folding mirror 15 and a resonator end mirror 16.

Like the resonator array shown in FIG. 6, the resonator array shown in FIG. 7 works by allowing the beam to pass multiple times through the disk-shaped laser crystal 11 and comprises an acousto-optical Q-switch 19, a safety lock 20 and a partially permeable outcoupling mirror 21 via which the laser output beam 18 exits from the resonator.

The pump assembly according to the present invention has a diode emitter width of, e.g., 800 μm and a 25 mm long homogenization element with a diameter of 1 mm.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. An optical arrangement for pumping solid-state lasers which, disposed along an optical axis, comprises a diode laser pump source for a pump beam, a rod-shaped homogenizer, and an optical focusing system wherein said homogenizer has two oppositely lying polished end surfaces as beam input and beam output surfaces, planar lateral boundary surfaces which are disposed parallel to said optical axis and a cross-sectional area perpendicular to the optical axis, said cross-sectional area forming a regular polygon, said polygon being limited to such a number of vertices that allows a space-filling side-by-side layout of a plurality of regular polygons on a plane.

2. The optical arrangement as in claim 1, wherein said end surfaces, with their surface normal, enclose an angle from an angular range with said optical axis, which angle ranges from 0° to and including Brewster's angle.

3. The optical arrangement as in claim 2, wherein said cross-sectional area of said homogenizer has the shape of a regular hexagon.

4. The optical arrangement as in claim 2, wherein said cross-sectional area of said homogenizer has the shape of a triangle.

5. The optical arrangement as in claim 2, wherein said cross-sectional area of said homogenizer has the shape of a rectangle.

6. The optical arrangement as in claim 1, wherein said end surfaces of said homogenizer are coated with an antireflection coating for in- and outcoupling said pump beam.

7. The optical arrangement as in claim 6, wherein said homogenizer is made of fused quartz or glass or a transparent plastic material.

8. The optical arrangement as in claim 7, wherein said homogenizer is enclosed by a lateral surface made of a low refractive index material.

9. The optical arrangement as in claim 7, wherein said homogenizer has a lateral surface that is coated with a dielectric coating.

10. The optical arrangement as in claim 8, wherein said refractive index jump on the lateral surface has been made to conform to the angular distribution of said pump beam.

11. The optical arrangement as in claim 6, wherein said homogenizer is a hollow body that is assembled from surface sections.

12. The optical arrangement as in claim 1, wherein at least one beam-shaping element and a focusing lens are disposed between said diode laser pump source and said homogenizer.

13. The optical arrangement as in claim 1, wherein said pump beam has a pump beam power greater than 10 W.

14. The optical arrangement as in claim 2, wherein said homogenizer has a subcomponent with a round cross section.

15. A solid-state laser comprising an optical arrangement as in claims 1 and having a disk-shaped laser crystal as the laser-active medium within a resonator, which laser crystal, with one reflecting disk surface that faces away from the inside of the resonator, is mounted on a cooling element and is placed opposite a reflector so as to allow the pump beam to pass through multiple times.

16. The solid-state laser as in claim 15 wherein the laser-active medium is a disk-shaped Yb:YAG laser crystal.

17. The solid-state laser as in claim 16 wherein a nonlinear optical crystal for generating the second harmonic is disposed inside the resonator in the beam path downstream of the disk-shaped laser crystal.

18. The solid-state laser as in claim 16 wherein the resonator comprises a Q-switch.

19. The solid-state laser as in claim 15 wherein the laser-active medium is a disk-shaped Nd:YAG, Nd:YVO₄, Nd:GdVO₄ or a YB-KYW laser crystal.

20. The solid-state laser as in claim 19 wherein a nonlinear optical crystal for generating the second harmonic is disposed inside the resonator in the beam path downstream of the disk-shaped laser crystal.

21. The solid-state laser as in claim 19 wherein the resonator comprises a Q-switch.
